(19) United States
(12) Patent Application Publication
(10) Pub. No.: US 2020/0393675 A1
(43) Pub. Date: Dec. 17, 2020

(54) HUD SYSTEM AND MULTI-SCREEN JOINED DIFFRACTION DISPLAY SYSTEM

(71) Applicant: Jing JIANG, Beijing (CN)

(72) Inventor: Zhengyu HUANG, Beijing (CN)

(21) Appl. No.: 16/976,943

(22) PCT Filed: Feb. 21, 2019
(86) PCT No.: PCT/CN2019/075682

§ 371 Date: Aug. 31, 2020

(30) Foreign Application Priority Data
Mar. 2, 2018 (CN) 201810175802.4

(51) Int. Cl. G02B 27/01; G02F 1/13357; G02B 27/42; G02B 27/30; G02B 26/08; B60K 35/00

(52) U.S. Cl. CPC G02B 27/0101; G02F 1/133615; G02B 27/4205; G02B 27/30; B60K 2370/52; B60K 35/00; G02B 2027/0141; B60K 2370/1529; G02B 26/0833

(57) ABSTRACT

A HUD system, comprising an optical engine and a diffractive projection screen; the optical engine is used for outputting a target image onto a display surface of said optical engine; the optical engine comprises a coherent light source, an image modulator, and a light diffusing device; the light diffusing device is used for diffusing light, causing the beams emitted by each pixel on the display surface to be divergent; the diffractive projection screen comprises a diffractive optical device, used for forming a virtual image of the target image by means of diffracting light from the optical engine; the projection region of the light beams emitted by each pixel on the display surface on the diffractive projection screen at least partially overlaps the projection region of the light beams emitted by a plurality of other pixels on the diffractive projection screen. Also disclosed is a multi-screen joined diffraction display system.

### TECHNICAL FIELD

The present invention generally relates to a diffraction display system, and, in particular, to a diffraction-based HUD system and a multi-screen joined diffraction display system especially suitable for use as a HUD system.

### BACKGROUND

When a vehicle is running at high speed, the driver's line of sight needs to be focused in the area in front of the driver at all times. When it is necessary to observe the information on the dashboard, the driver's attention will briefly shift from the front area to the dashboard of the vehicle. If an abnormal situation happens ahead at the moment, it may be too late for the driver to take effective measures as a response, thereby leading to an accident. Thus, drivers need to observe both the road information and the driving information at the same time. In order to solve this problem, Head Up Display (HUD) is introduced into automobile.

A vehicle-mounted Head Up Display projects into human eyes the vehicle speed, fuel consumption, navigation map and other important information needed most during driving, and the projection image is located at an appropriate position in front of the driver so as to enable the driver to always keep the head-up posture, avoid the potential safety hazard caused by looking down at the information displayed on the dashboard, reduce the possibility of a traffic accident, and relieve the eyestrain caused by the alternate observation of near and far scenery information inside and outside the vehicle. The vehicle-mounted Head Up Display can make drivers obtain the needed driving information in a safer and quicker manner, and is of great significance in the aspect of improving the safety performance of vehicles.

In order to ensure the basic driver's field of vision, as well as the display window when the driver's head moves to the left or right, a traditional vehicle-mounted Head Up Display needs to be achieved by designing a collimating optical path and a folded optical path inside the same based on optical lens, prism and other optical devices. The existence of these optical devices and optical paths makes the vehicle-mounted Head Up Display large in volume and expensive in cost, and it is quite difficult to embed the Head Up Display into such a compact layout as in the dashboard of an automobile. For example, as described in the U.S. Pat. No. 6,359,737, imaging is made by a traditional projector onto the front windshield of an automobile. However, this requires the projector to be equipped with optical components to adapt to the different curvature of the front windshield in different vehicle models. Therefore, the current embedded vehicle-mounted head up display is a compromise product in volume, cost and optical effect in order to make its commercialization possible. However, some problems remain, such as driver's smaller field of vision and smaller window. For example, the vehicle-mounted head up display, as described in the U.S. Pat. No. 6,359,737, has a volume of 10 liters and a field of view of only 5 degrees.

Therefore, as the automobile industry develops, a vehicle-mounted Head Up Display is required with a smaller volume, compact layout and low costs, while a large field of vision for display and large display window in the optical performance.

### SUMMARY

The purpose of the present invention is to provide a diffraction-based HUD system and a multi-screen joined diffraction display system especially suitable for use as a HUD system, which at least partially solves the aforesaid problem that exists in the prior art.

According to one aspect of the present invention, provided is a HUD system, comprising an optical engine and a diffractive projection screen. The optical engine is used for outputting a target image onto a display surface thereof, and comprises a coherent light source, an image modulator that modulates light emitted by the coherent light source to obtain a light spatial distribution corresponding to the target image, and a light diffusing device arranged on an optical path from the coherent light source to the display surface and used for diffusing light, causing the light beams emitted by each pixel on the display surface to be divergent. The diffractive projection screen comprises a diffractive optical device for forming a virtual image of the target image by means of diffracting the light from the optical engine; the projection region of the light beams emitted by each pixel on the display surface on the diffractive projection screen at least partially overlaps the projection region of the light beams emitted by a plurality of other pixels on the diffractive projection screen.

The coherent light source is preferably a laser light source.

The projection region of the light beams emitted by each pixel on the display surface on the diffractive projection screen may substantially cover the whole diffractive projection screen.

The diffractive projection screen may diffract light from each pixel on the display surface to form parallel or approximately parallel imaging beams, and the projection directions of the imaging beams corresponding to different pixels are different from each other.

The diffractive optical device may comprise at least one of a holographic film, a computer-generated hologram (CGH), a holographic optical element (HOE) or a diffractive optical element (DOE). The diffractive optical device may comprise a monolayered or a multilayered structure used for different wavelengths.

In some embodiments, the image modulator comprises a spatial light modulator, the light diffusing device comprises a diffuser arranged upstream of the spatial light modulator along the optical path from the coherent light source to the display surface, and the display surface is formed on the spatial light modulator.

In some embodiments, the image modulator is an LCD, and the coherent light source and the diffuser constitute a backlight assembly for the LCD.

In some embodiments, the image modulator comprises a spatial light modulator, the light diffusing device comprises a diffusing screen arranged downstream of the spatial light modulator along the optical path from the coherent light source to the display surface, and the display surface is formed on the diffusing screen.

In some embodiments, the optical engine also comprises a beam expander arranged between the coherent light source and the image modulator and used for expanding light from the coherent light source to illuminate the whole incident surface of the image modulator. Preferably, the beam expander also collimates the light from the coherent light source to obtain substantially collimated light beams to illuminate the image modulator.

The image modulator may be an LCD, an LCOS or a DMD.

In some embodiments, the image modulator comprises a scanning galvanometer, the light diffusing device comprises a diffusing screen arranged downstream of the scanning galvanometer along the optical path from the coherent light source to the display surface, and the display surface is formed on the diffusing screen.

In some embodiments, the light diffusing device comprises a scattering element, a micro mirror array, a micro prism array, a micro lens array, a HOE, a CGH, a DOE, or a combination thereof.

In some embodiments, the light diffusing device may be further configured in such a manner as to enable light beams emitted therefrom corresponding to each pixel to have a specific spatial angular distribution, such that the light energy is concentrated for projection towards the diffractive projection screen. For example, the light diffusing device may be configured in such a manner as to enable the center light of the light beams emitted thereby corresponding to each pixel to deviate from a direction perpendicular to the light diffusing device. Such light diffusing device may include at least one of an aperture array, a micro mirror array, a micro prism array, a micro lens array, a grating, a HOE, a CGH and a DOE.

In some embodiments, the optical engine also includes a directional projecting device arranged downstream of the light diffusing device along the optical path from the coherent light source to the display surface, and configured to limit a divergence angle of light beams emitted therefrom corresponding to each pixel and/or change a direction of the center light of the light beams to enable the light beams to have a specific spatial angular distribution, such that the light energy is concentrated for projection towards the diffractive projection screen. In some advantageous embodiments, the center light of the light beams emitted by the directional projecting device corresponding to each pixel deviates from a direction perpendicular to the directional projecting device.

The directional projecting device may be arranged upstream of the image modulator along the optical path from the coherent light source to the display surface, and the display surface is formed on the image modulator; or the directional projecting device may be arranged downstream of the image modulator along the optical path from the coherent light source to the display surface, and the display surface is formed on the directional projecting device.

The directional projecting device may include an aperture array, a micro mirror array, a micro prism array, a micro lens array, a grating, a HOE, a CGH, a DOE, or a combination thereof.

According to another aspect of the present invention, provided is a multi-screen joined diffraction display system, comprising a first optical engine and a second optical engine, as well as a first diffractive projection screen and a second diffractive projection screen. The first optical engine and the second optical engine each have a display surface for outputting a target image, either of which comprises a laser light source, an image modulator that modulates light emitted by the laser light source to obtain a light spatial distribution corresponding to the target image, and a light diffusing device arranged on an optical path from the laser light source to the display surface and used for diffusing light, causing the light beams emitted by each pixel on the display surface to be divergent. The first diffractive projection screen and the second diffractive projection screen are adjacent to each other and each comprise a diffractive optical device for forming virtual images of the target images output by the first optical engine and the second optical engine respectively; a first edge of the first diffractive projection screen and a second edge of the second diffractive projection screen are opposite and adjacent to each other; the projection region of the light beams emitted by each pixel on the display surface of the first optical engine or the second optical engine on the corresponding diffractive projection screen at least partially overlaps the projection region of the light beams emitted by a plurality of other pixels on the same display surface on the same diffractive projection screen. Among them, an edge portion comprising a first side edge of the image modulator of the first optical engine and an edge portion comprising a second side edge of the image modulator of the second optical engine are used to display the same content, and the imaging beams formed by means of diffracting the pixels corresponding to each other in the two edge portions respectively through the first diffractive projection screen and the second diffractive projection screen are parallel to each other.

The first diffractive projection screen and the second diffractive projection screen may diffract light from each pixel on the corresponding display surface to form parallel or approximately parallel imaging beams, and the projection directions of the imaging beams corresponding to different pixels are different from each other.

The projection region of the light beams emitted by each pixel on the display surface on the corresponding diffractive projection screen may substantially cover the whole diffractive projection screen.

In some embodiments, the edge portions of the image modulators of the first optical engine and the second optical engine have a predetermined width in a direction perpendicular to the first side edge and the second side edge respectively, and the predetermined width corresponds to the width of the design window of the multi-screen joined diffraction display system.

In some embodiments, light emitted by a pixel at the first side edge of the image modulator of the first optical engine is diffracted at the first edge of the first diffractive projection screen to form light beams that pass through a first boundary of the design window of the multi-screen joined diffraction display system, and light emitted by a pixel at the second side edge of the image modulator of the second optical engine is diffracted at the second edge of the second diffractive projection screen to form light beams that pass through a second boundary, opposite to the first boundary, of the design window of the multi-screen joined diffraction display system.

The first optical engine and the second optical engine may be arranged in such a manner as to enable the first side edge and the second side edge of their image modulators to be opposite to each other.

The image modulators of the first optical engine and the second optical engine may be integrated into one.

The first optical engine and the second optical engine may share the laser light source and/or the light diffusing device.

The first optical engine and the second optical engine may also be arranged to be spatially distant from each other.

In some embodiments, the multi-screen joined diffraction display system is configured into a HUD system.

Preferably, the width of a gap between the first diffractive projection screen and the second diffractive projection screen is less than or equal to 2 mm (i.e. the lower limit of the average pupil diameter of human); and preferably, the first diffractive projection screen and the second diffractive projection screen are seamlessly joined.

In some embodiments, the image modulator may be a DMD or a MEMS-based scanning galvanometer. In such embodiments, the light diffusing device may be a diffusing screen arranged downstream of the image modulator along the optical path from the laser light source to the display surface, the display surface is formed on the diffusing screen, and the diffusing screen is configured in such a manner as to enable the light beams emitted therefrom corresponding to each pixel to have a specific spatial angular distribution, such that the light energy is concentrated for projection towards the corresponding diffractive projection screen.

In some advantageous embodiments, the first optical engine projects a target image output thereby only onto the first diffractive projection screen, and the second optical engine projects a target image output thereby only onto the second diffractive projection screen.

The light diffusing device may include a scattering element, a micro mirror array, a micro prism array, a micro lens array, a HOE, a CGH, a DOE or a combination thereof.

In some advantageous embodiments, the light diffusing device is further configured in such a manner as to enable the light beams emitted therefrom corresponding to each pixel to have a specific spatial angular distribution, such that the light energy is concentrated for projection towards the diffractive projection screen. For example, the light diffusing device may be configured in such a manner as to enable the center light of the light beams emitted thereby corresponding to each pixel to deviate from a direction perpendicular to the light diffusing device. Such light diffusing device may include at least one of an aperture array, a micro mirror array, a micro prism array, a micro lens array, a grating, a HOE, a CGH and a DOE.

In some advantageous embodiments, the optical engine also includes a directional projecting device arranged downstream of the light diffusing device along the optical path from the laser light source to the display surface, and configured to limit a divergence angle of the light beams emitted therefrom corresponding to each pixel and/or change a direction of the center light of the light beams to enable the light beams to have a specific spatial angular distribution, such that the light energy is concentrated for projection towards the diffractive projection screen. For example, the directional projecting device may be configured in such a manner as to enable the center light of the light beams emitted thereby corresponding to each pixel to deviate from a direction perpendicular to the directional projecting device.

The directional projecting device may be arranged upstream of the image modulator along the optical path from the coherent light source to the display surface, and the display surface is formed on the image modulator; or the directional projecting device may be arranged downstream of the image modulator along the optical path from the laser light source to the display surface, and the display surface is formed on the directional projecting device.

The directional projecting device may include an aperture array, a micro mirror array, a micro prism array, a micro lens array, a grating, a HOE, a CGH, a DOE, or a combination thereof.

### BRIEF DESCRIPTION OF THE DRAWINGS

Other features, purposes and advantages of the present invention will be more apparent by reading the detailed description of the non-limitative embodiments with reference to the following drawings:

FIG. 1 is a schematic diagram of a HUD system according to the first embodiment of the present invention, in which an LCD is used as an image modulator and a diffuser is arranged between the coherent light source and the image modulator;

FIG. 2 schematically shows the influence of the diffuser on the light-emitting beams of each pixel on the image modulator;

FIG. 3 schematically shows an exemplary formation method of a diffractive optical device for use in the diffractive projection screen of the HUD system shown in FIG. 1;

FIG. 4 shows a diffractive optical device that can be used in the diffractive projection screen of the HUD system shown in FIG. 1, which has a multilayered structure used for different wavelengths respectively;

FIGS. 5A to 5D schematically show different examples of a diffuser that can be used in the HUD system shown in FIG. 1;

FIG. 6 is a schematic diagram of a HUD system according to a variant of the first embodiment of the present invention, wherein a directional projecting device is arranged downstream of the optical diffusing device;

FIGS. 7A, 7B and 7C schematically show multiple examples of a directional projecting device that can be used in a display system according to one embodiment of the present invention;

FIG. 8 shows an example of a directional projecting device integrated on the surface of a light diffusing device;

FIGS. 9A, 9B, 9C and 9D schematically show other examples of a directional projecting device that can be used in a display system according to one embodiment of the present invention;

FIG. 10 is a schematic diagram of a HUD system according to another variant of the first embodiment of the present invention;

FIG. 11 shows a schematic enlarged view of the image modulator, the light diffusing device, and the directional projecting device in the HUD system shown in FIG. 10;

FIG. 12 is a schematic diagram of a HUD system according to the second embodiment of the present invention, in which an LCD is used as an image modulator and a diffusing screen is arranged downstream of the image modulator;

FIG. 13 is a schematic diagram of a HUD system according to a variant of the second embodiment of the present invention;

FIG. 14 schematically shows a change of the spatial angular distribution of the light in the optical path of the HUD system shown in FIG. 13;

FIG. 15 is a schematic diagram of a HUD system according to another variant of the second embodiment of the present invention;

FIG. 16 is a schematic diagram of a HUD system according to the third embodiment of the present invention;

FIG. 17 shows another possible arrangement of the HUD system shown in FIG. 16;

FIGS. 18A and 18B schematically show examples of a light diffusing device that can be used in the HUD system shown in FIGS. 16 and 17, and FIG. 18C schematically illustrates an example of a combination of a light diffusing device and a directional projecting device that can be used in the HUD system shown in FIGS. 16 and 17;

FIG. 19 is a schematic diagram of a HUD system according to the fourth embodiment of the present invention;

FIG. 20 is a schematic diagram of a HUD system according to a variant of the fourth embodiment of the present invention;

FIG. 21 is a schematic diagram of a HUD system according to the fifth embodiment of the present invention;

FIG. 22 is a schematic diagram of a HUD system according to a variant of the fifth embodiment of the present invention;

FIGS. 23A and 23B schematically show examples of a light diffusing device that can be used in the HUD systems shown in FIGS. 21 and 22;

FIG. 24 is a schematic diagram of a HUD system according to the sixth embodiment of the present invention;

FIG. 25 is a schematic diagram of a HUD system according to the seventh embodiment of the present invention;

FIG. 26 is a schematic diagram of a HUD system according to a variant of the seventh embodiment of the present invention;

FIG. 27 schematically shows a diffraction display system including, for example, a plurality of display subsystems according to the first to the seventh embodiments of the present invention;

FIGS. 28A to 28F illustrate the imaging by a multi-screen diffraction display system including two independent display subsystems;

FIG. 29 is a schematic diagram of a multi-screen joined diffraction display system according to the eighth embodiment of the present invention; and

FIGS. 30A to 30D schematically illustrate the imaging by the multi-screen joined diffraction display system according to the eighth embodiment of the present invention.

### DETAILED DESCRIPTION

The present invention will be further described below in detail with reference to the drawings and embodiments. It may be understood that the specific embodiments set forth herein are only used to explain the related inventions, instead of making limitations of the same. In addition, it should be noted that only parts related to invention are shown in the drawings for the convenience of description.

It should be noted that the embodiments of the present application and the features therein can be combined with each other in case of no conflicting. The present invention will be explained below in detail with reference to the drawings together with the embodiments.

### The First Embodiment

FIG. 1 is a schematic diagram of a HUD system 100 according to the first embodiment of the present invention. As shown in FIG. 1, the HUD system 100 according to the first embodiment of the present application comprises an optical engine 110 and a diffractive projection screen 120.

The optical engine 110 is used for outputting a target image on a display surface thereof (the display surface may be located on different device surfaces according to the different configurations of the optical engine), and the optical engine 110 includes, but not limited to, a coherent light source 111, an image modulator 112, and a light diffusing device 113. The image modulator 112 modulates light emitted by the coherent light source 111 to obtain a light spatial distribution corresponding to the target image (including the distribution of light wavelength and light intensity corresponding to the spatial position of each pixel). The light diffusing device 113 is arranged on an optical path from the coherent light source 111 to the display surface and used for diffusing light, causing the light beams emitted by each pixel on the display surface to be divergent (to form a spherical wave or an approximately spherical wave).

As shown in the drawing, the optical engine may be mounted or integrated onto the top or other positions of the dashboard of an automobile, for example.

The diffractive projection screen 120 comprises a diffractive optical device 120a for forming a virtual image of the target image by means of diffracting the light from the optical engine. Among others, the projection region of the light beams emitted by each pixel on the display surface of the optical engine 110 on the diffractive projection screen 120 at least partially overlaps with the projection regions of the light beams emitted by a plurality of other pixels on the diffractive projection screen 120. In some examples, the projection region of the light beams emitted from each pixel on the diffractive projection screen 120 can also substantially cover the whole diffractive projection screen.

The diffractive projection screen 120 may generally be arranged on, for example, the windshield of a vehicle or an aircraft, which is marked by “WS” in the drawing. For example, the diffractive optical element 120a of the diffractive projection screen 120 may be formed directly on the windshield WS, and may also be formed independently and then attached to the windshield surface, or, for example, sandwiched between possibly more than one layer of the windshield WS. In other cases, the diffractive projection screen 120 may also be formed as a separately provided and mounted member, for example, it may also include a substrate to carry the diffractive optical device 120a. It should be understood that the explanation made above is not restrictive, but illustrative only.

In order to form a distant and magnified virtual image of the target image to make it easy for users of the HUD system to view the image, the diffractive projection screen 120 can diffract light from each pixel on the display surface of the optical engine 110 to form parallel or approximately parallel imaging beams, and the projection directions of the imaging beams corresponding to different pixels are different from each other. In this way, due to the effect of the user's eyeball E on the light beams corresponding to each pixel from the optical engine, a corresponding image point can be formed on the retina, and different pixels form image points at different positions of the human eye's retina, such that the user can observe the magnified virtual image at or near infinity.

According to the embodiments of the present invention, the image modulator may be achieved using a spatial light modulator. For example, in the HUD system 100 according to the first embodiment of the present invention, an LCD is used as the image modulator 112 as shown in FIG. 1. As the image modulator, LCD 112 modulates the intensity of light passing through each pixel thereof. After being modulated by LCD 112, the light on the light emergent surface of the LCD 112 has a light spatial distribution corresponding to the target image. In the HUD system 100 according to the embodiment, the display surface is formed on the light emergent surface of the LCD 112.

The coherent light source 110 is preferably a laser light source or may be a white light source with a narrow-band filter, for example. In consideration of the use of the HUD system in different ambient light conditions such as day and night, the coherent light source 110 may also be formed switchable between more than one light sources. In addition, the coherent light source 110 can provide monochromatic coherent light, and can also provide polychromatic coherent light, such as the trichromatic light including red, green and blue light.

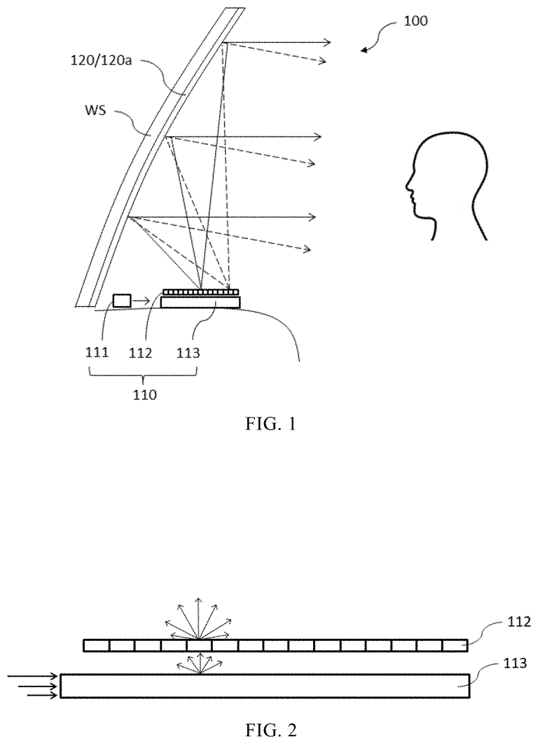

According to the embodiment, the light diffusing device 113 may be a diffuser arranged on the optical path between the coherent light source 111 and the image modulator 112. In some examples, the coherent light source 111 and the diffuser 113 may constitute a backlight assembly for the LCD 112, as shown in FIG. 1. The light from the coherent light source 111 enters, and then is diffused by, the diffuser 113. Due to the diffusion, the light emitted from each point on the surface of the diffuser 113 right towards the LCD 112 has a divergent spatial angular distribution. The LCD 112 generally does not change the direction of the light, so the light beams emitted from each pixel of the LCD 112 maintain the divergent spatial angular distribution of the emergent light from the diffuser 113 (see FIG. 2). The divergent spatial angular distribution makes the projection region of the light beams emitted by each pixel on the display surface of the optical engine 110 on the diffractive projection screen 120 at least partially overlap with the projection regions of the light beams emitted by a plurality of other pixels on the diffractive projection screen 120. For example, in some examples, points on the light emergent surface of the diffuser 113 can approximately form a Lambertian light source. Certainly, the present invention is not limited to the formation of a Lambertian light source.

The diffractive optical device used in the present invention may comprise at least one of a holographic film, a computer-generated hologram (CGH), a holographic optical element (HOE) or a diffractive optical element (DOE).

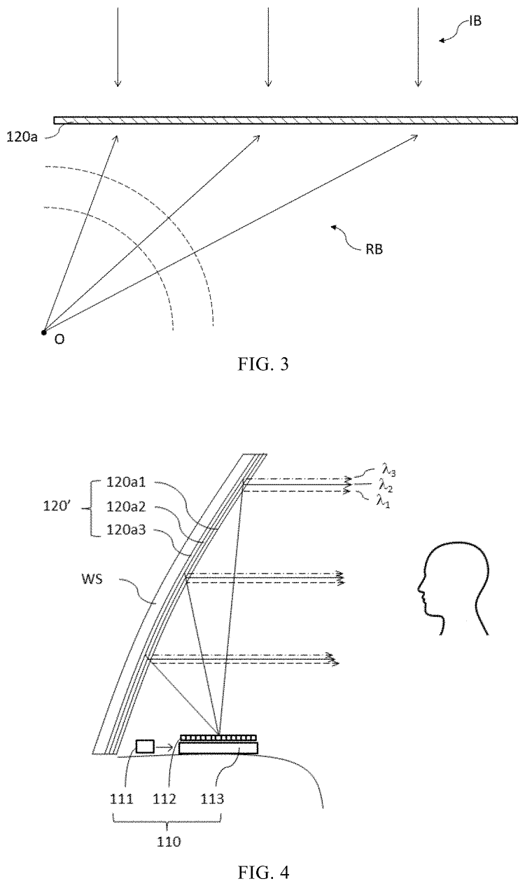

By taking a holographic film as an example to be used as the diffractive optical device, FIG. 3 schematically shows an exemplary formation method of a diffractive optical device for use in the reflection-type diffractive projection screen. As shown in FIG. 3, in order to obtain the reflection-type diffractive optical device 120a, a reference light RB and an object light IB can be respectively irradiated from the two different sides of the photosensitive glue layer, where the reference light RB is a spherical wave from the point light source O, and the object light IB is a plane wave. After exposure, a holographic film with a hologram or a dry plate for making the holographic film is formed, where the dry plate can be used as a mold to produce the holographic film by means of coining. In order to achieve a better display effect, the exposure can also be made by using the method of moving the light source point O of the reference light/using the light source points O of multiple reference light. In addition, the hologram can also be generated by computer, processed into a motherboard by means of electron beam/etching, and then a diffractive optical device with the hologram may be produced by coining.

FIG. 4 shows a diffractive optical device that can be used in the diffractive projection screen according to the embodiment of the present invention, where the diffractive optical device has multiple diffractive layers 120a1, 120a2, 120a3 used for different wavelengths λ₁, λ₂, λ₃ respectively, all of which are configured in such a manner that imaging beams obtained by spherical waves emitted from the same point A through the diffractive layers 120a1, 120a2, 120a3 are parallel or substantially parallel to each other. However, what is shown in FIG. 4 only serves as an example, and the diffractive optical device may also have a monolayered structure for different wavelengths, or a combination of a layered structure for a single wavelength and a layered structure for two or more wavelengths.

Although the diffractive projection screen and the diffractive optical device included therein are introduced above in the first embodiment, it should be understood that the above content is also applicable to other embodiments of the present invention and will not be repeated below.

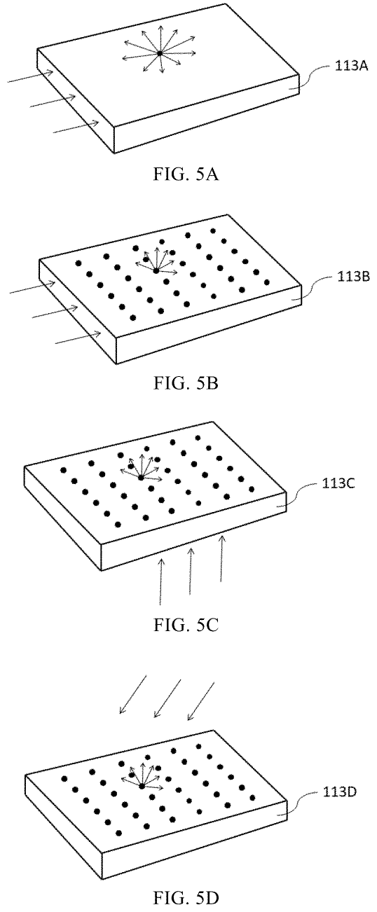

FIGS. 5A to 5D schematically show different examples of a diffuser that can be used in the HUD system according to the first embodiment of the present invention. FIG. 5A shows a diffuser 113A in the form of a light guide plate, in which light from the coherent light source, for example, enters the diffuser from the side, then goes through refraction, reflection and/or diffraction within the diffuser, and light with a divergent spatial angular distribution emits from, for example, points on the light emergent surface (i.e. the upper surface shown in the drawing). In some examples, the points may form a Lambertian light source, but the present invention is not limited to this. The diffuser 113B shown in FIG. 5B, though similar to the diffuser 113A shown in FIG. 5A, differs in that light is emitted only at a predetermined lattice position on the light emergent surface of the diffuser 113B, and the lattice preferably corresponds to a pixel lattice on the image modulator, such as an LCD. The lattice can be implemented using, for example, an aperture array or a combination of an aperture array and a micro lens array, but the present invention is not limited to this particular form. The diffuser 113C shown in FIG. 5C is similar to the diffuser 113B shown in FIG. 5B, while the difference therebetween merely lies in the incident position of light from the light source, and the light, for example, can be incident from a surface opposite to the light emergent surface. In addition, the diffuser may also be formed to be reflection-type. For example, as shown in FIG. 5D, the diffuser 113D reflects the incident light, thereby generating light with a divergent spatial angular distribution on the reflecting surface. When a diffuser 113D of such type is combined with an LCD, it is necessary to keep a certain distance from the back of the LCD such that light from the coherent light source can illuminate onto the diffuser 113D. The diffuser 113D may include, for example, a micro reflecting mirror array (a micro convex mirror array and/or a micro concave mirror array), or a combination thereof with an aperture. Obviously, the above diffusers may also be formed by, for example, DOE, HOE, CGH, or their combination with other structures.

The description made above with reference to FIG. 5 is not restrictive, but illustrative only. According to the embodiment of the present invention, the light diffusing device may include a scattering element, a micro mirror array, a micro prism array, a micro lens array, a DOE, a HOE, a CGH or a combination thereof.

### Variants of the First Embodiment

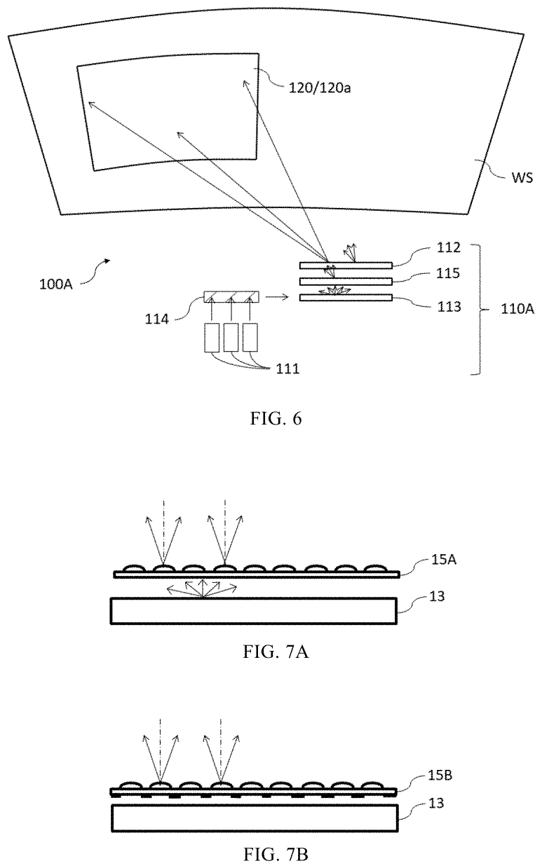

Next, HUD systems 100A and 100B according to the variants of the first embodiment of the present invention are described with reference to FIGS. 6 to 11. In the HUD systems 100A and 100B according to the variants of the first embodiment of the present invention, a directional projecting device 115 is arranged downstream of the optical diffusing device 113 along the optical path from the coherent light source to the display surface, and configured to limit a divergence angle of the light beams emitted therefrom corresponding to each pixel and/or change a direction of the center light of the light beams to enable the light beams to have a specific spatial angular distribution, such that the light energy is concentrated for projection towards the diffractive projection screen.

FIG. 6 is a schematic diagram of a HUD system 100A according to a variant of the first embodiment of the present invention. As shown in FIG. 6, in the HUD system 100A, a directional projecting device 115 is arranged between the optical diffusing device 113 and the image modulator 112 (an LCD in the first embodiment). In this case, the display surface of the optical engine 110 is formed on the image modulator 112.

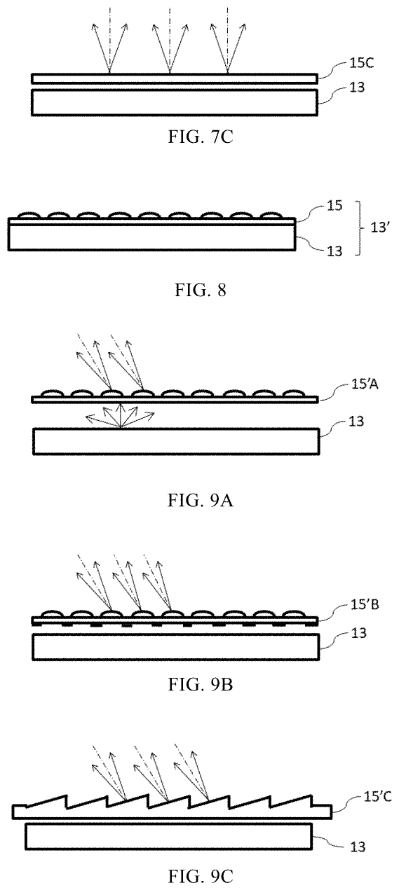

FIGS. 7A, 7B, and 7C schematically show multiple examples of a directional projecting device that can be used in a display system according to one embodiment of the present invention. As shown in FIG. 7, the directional projecting device may be configured to limit a divergence angle of the light beams emitted therefrom corresponding to each pixel to enable the light beams to have a specific spatial angular distribution, such that the light energy is concentrated for projection towards the diffractive projection screen.

As shown in FIGS. 7A, 7B and 7C, the directional projecting devices 15A, 15B and 15C receive divergent light from the light diffusing device 13 and limit a divergence angle of the light to an angle α so as to enable the directional projection. In the example shown in FIG. 7A, the directional projecting device 15A includes a micro lens array; in the example shown in FIG. 7B, the directional projecting device 15B includes a combination of a micro lens array and an aperture array; and in the example shown in FIG. 7C, the directional projecting device 15C includes diffracting devices such as HOE, CGH, DOE, etc. It should be understood that FIG. 7 is merely exemplary, and the directional projecting device 15 that can be used for the present invention is not limited to the configurations enumerated above, but may include, for example, an aperture array, a micro mirror array, a micro prism array, a micro lens array, a grating, a HOE, a CGH, a DOE, or a combination thereof.

Although the directional projecting device 15 shown in FIG. 7 is formed as a separate device from the light diffusing device 13, both may also be integrated together. For example, as shown in FIG. 8, the directional projecting device 15 may be integrated on the surface of the light diffusing device 13. By this, it can also be considered that both constitute a new-type optical diffusing device 13′, which can not only provide the function of light diffusion, but also have the function of light directional projection, that is, to enable light beams emitted therefrom corresponding to each pixel to have a specific spatial angular distribution, such that the light energy is concentrated for projection towards the diffractive projection screen.

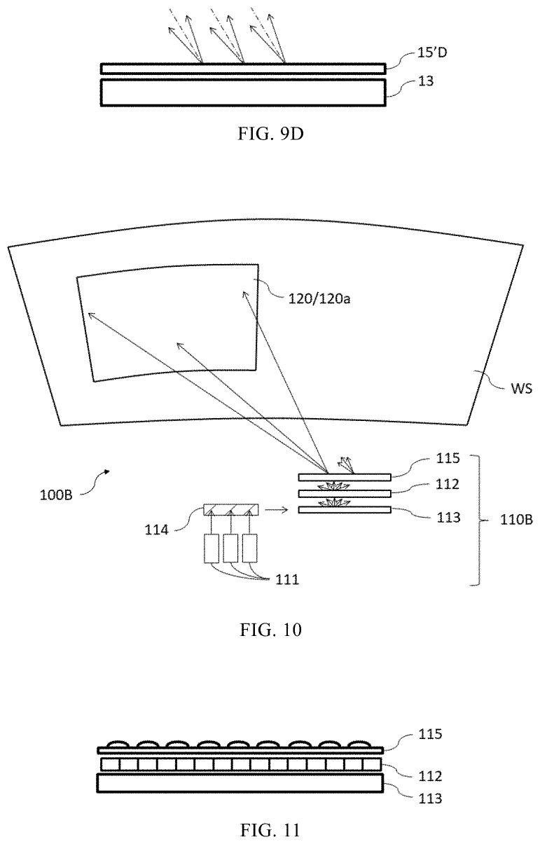

FIGS. 9A, 9B, 9C and 9D schematically show other examples of a directional projecting device that can be used in a display system according to one embodiment of the present invention. As shown in FIG. 9, the directional projecting device may be configured to limit a divergence angle of the light beams emitted therefrom corresponding to each pixel and change a direction of the center light of the light beams to enable the light beams to have a specific spatial angular distribution, such that the light energy is concentrated for projection towards the diffractive projection screen. Use of a directional projecting device of such type particularly facilitates, for example, a more flexible selection of the location where the optical engine is mounted.

As shown in FIGS. 9A, 9B, 9C and 9D, the directional projecting devices 15′A, 15′B, 15′C and 15′D receive divergent light from the light diffusing device 13, and limit a divergence angle of the light to an angle α and change a direction of the center light of the light beams corresponding to each pixel to make the same deviate from a direction perpendicular to the directional projecting device and concentrated for projection towards the diffractive projection screen, so as to enable the directional projection. In the example shown in FIG. 9A, the directional projecting device 15′A includes a micro lens array; in the example shown in FIG. 9B, the directional projecting device 15′B includes a combination of a micro lens array and an aperture array; in the example shown in FIG. 9C, the directional projecting device 15′C includes a micro mirror array; and in the example shown in FIG. 9D, the directional projecting device 15′D includes diffracting devices such as HOE, CGH, DOE, etc. It should be understood that FIG. 9 is merely exemplary, and the directional projecting device 15′ that can be used for the present invention is not limited to the configurations enumerated above, but may include, for example, an aperture array, a micro mirror array, a micro prism array, a micro lens array, a grating, a HOE, a CGH, a DOE, or a combination thereof.

Similar to the case shown in FIG. 8, the directional projecting device 15′ may also be integrated together with the light diffusing device 13.

As an example only, FIG. 6 also shows that the coherent light source 111 in the optical engine 110A may include a plurality of lasers, such as a red, green and blue lasers, and in one preferred example, the optical engine 110A may also include a laser beam combiner for combining laser beams emitted by the multiple lasers and transmitting the same to the light diffusing device 113.

FIG. 10 shows a HUD system 100B according to another variant of the first embodiment of the present invention. As shown in FIG. 10, the directional projecting device 115 may also be arranged on an optical path downstream of the image modulator 112. In this case, the display surface of the optical engine 110 is formed on the directional projecting device 115.

FIG. 11 is a schematic enlarged view of the image modulator 112, the light diffusing device 113 and the directional projecting device 115 in the HUD system 100B shown in FIG. 10. As shown in FIG. 11, the image modulator 112, the light diffusing device 113 and the directional projecting device 115 may be configured in a stacked structure.

It should be understood that the directional projecting device in the HUD system 100B shown in FIG. 10 may be formed using the directional projecting devices 15 and 15′ as shown in FIGS. 7 and 9, or any suitable directional projecting device configured otherwise, though not shown.

Moreover, a directional projecting device used in the HUD system according to other embodiments or variants thereof may also be formed using the directional projecting devices 15 and 15′ as shown in FIGS. 7 and 9, or any suitable directional projecting device configured otherwise. This will not be stressed any more below.

### The Second Embodiment and Variants Thereof

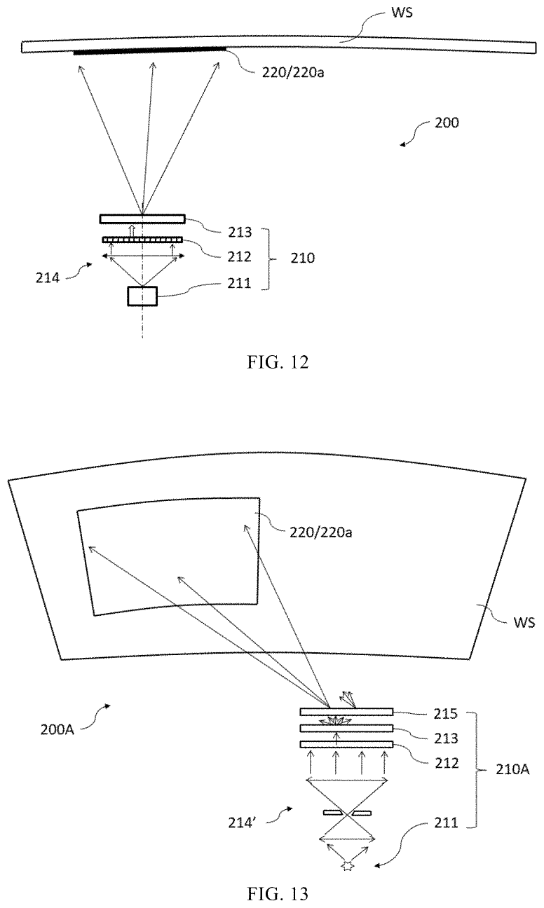

FIG. 12 is a schematic diagram of a HUD system 200 according to the second embodiment of the present invention. The HUD system 200 according to the second embodiment of the present invention is substantially the same in structure as the HUD system according to the first embodiment of the invention, in which an LCD is also used as an image modulator. The major difference between both is that the light diffusing device in the HUD system 200 is formed using a diffusing screen 213 located downstream of the image modulator.

Specifically, as shown in FIG. 12, the HUD system 200 comprises an optical engine 210 and a diffractive projection screen 220. The optical engine 210 includes a coherent light source 211, an LCD 212 as an image modulator, and a diffusing screen 213 on an optical path downstream of the LCD 212. In the illustrated example, the optical engine 210 optionally further includes a beam expander 214 for expanding light from the coherent light source 211 to illuminate the whole surface of the LCD 212. Preferably, the beam expander 214 also collimates the light. The light with good directivity emitted from each pixel of the LCD 212 illuminates onto the diffusing screen 213, and forms into light with a divergent spatial angular distribution (a spherical or approximate spherical wave) corresponding to each pixel after the diffusion by the diffusing screen 213. By this, the display surface of the optical engine 210 is formed on the light emergent surface of the diffusing screen 213.

Although the diffusing screen 213 is a transmission type in the example shown in FIG. 12, it may also be reflective. In addition, the diffusing screen may have a configuration similar to that of the diffuser described above with reference to FIG. 5, but the difference lies in that the diffusing screen is configured in such a manner as to make no change to the light spatial distribution corresponding to the target image, which has been modulated and formed by the image modulator. In other words, the diffusing screen has an independent diffusion effect on the light of each pixel, and the light of different pixels basically will not be mixed during the process of diffusion. As an example, the diffusing screen may be composed of, for example, a thin ground glass sheet, or may include, for example, a micro lens array. Based on the above description, those skilled in the art can understand that according to the embodiment of the present invention, the light diffusing device (including a diffuser and diffusing screen) may include a scattering element, a micro mirror array, a micro prism array, a micro lens array, a DOE, a HOE, a CGH or a combination thereof. As for other embodiments of the present invention to be introduced below, the above description on the diffusing screen is also applicable, and will not be repeated in the following.

FIG. 13 is a schematic diagram of a HUD system according to a variant of the second embodiment of the present invention. Similar to the HUD system according to the variant of the first embodiment of the present invention, the HUD system 200A according to the variant of the second embodiment of the present invention is also added with a directional projecting device 215 arranged downstream of the diffusing screen 213. FIG. 14 schematically shows a change of the spatial angular distribution of the light corresponding to each pixel in the optical path of the HUD system shown in FIG. 13 after passing through the image modulator 12, the diffusing screen 13 and the directional projecting device 15 in turn. In the example shown in FIG. 14, the light that passes through the image modulator 12 maintains good directivity, and as indicated by the single arrow on the left side of the image modulator 12, the light beam corresponding to one pixel have substantially the same direction; the light passing through the diffusing screen 13 has a divergent spatial angular distribution; while as for the light passing through the directional projecting device 15, a divergence angle of the spatial angular distribution is limited to a smaller degree, and a direction of the center light of the light beams is changed to achieve the directional projection. In the examples shown in FIGS. 13 and 14, the directional projecting device 215 is configured to limit a divergence angle of the light beams emitted therefrom corresponding to each pixel and change a direction of the center light of the light beams to enable the light beams to have a specific spatial angular distribution, such that the light energy is concentrated for projection towards the diffractive projection screen. Such a directional projecting device 215 may be formed using, for example, the directional projecting device described with reference to FIG. 9.

According to the relative position relationship between the optical engine 210 and the diffractive projection screen 220, the HUD system 200A in other examples may also use the directional projecting device 215 that only limits the divergence angle of the light beams, such as the directional projecting device 15 described with reference to FIG. 7.

In one preferred example, as shown in FIG. 13, the optical engine 210A of the HUD system 200A may also include a beam expanding and collimating device 214′, which expands the diameter of light beams from the coherent light source 211 and collimates the light beams so as to better illuminate the LCD 212 as an image modulator.

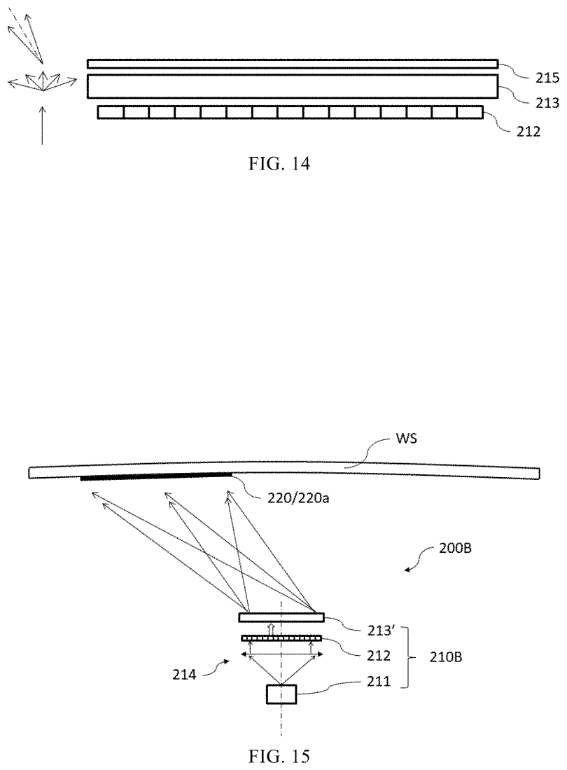

FIG. 15 shows a HUD system 200B according to another variant of the second embodiment of the present invention, where the diffusing screen 213′ per se is configured to limit a divergence angle of the light beams emitted therefrom corresponding to each pixel to enable the light beams emitted therefrom corresponding to each pixel to have a specific spatial angular distribution, such that the light energy is concentrated for projection towards the diffractive projection screen. The diffusion screen 213′ may also be further configured to change a direction of the center light of the light beams emitted therefrom corresponding to each pixel to make same, for example, deviate from a direction perpendicular to the light diffusing device. Such a diffusing screen 213′ may include one or more of, for example, a micro mirror array, a micro prism array, a micro lens array, a grating, a HOE, a CGH and a DOE.

The HUD system according to the embodiment of the present invention may also be achieved using an image modulator in other forms than LCD. HUD systems comprising different image modulators according to the embodiments of the present invention will be introduced below.

### The Third Embodiment

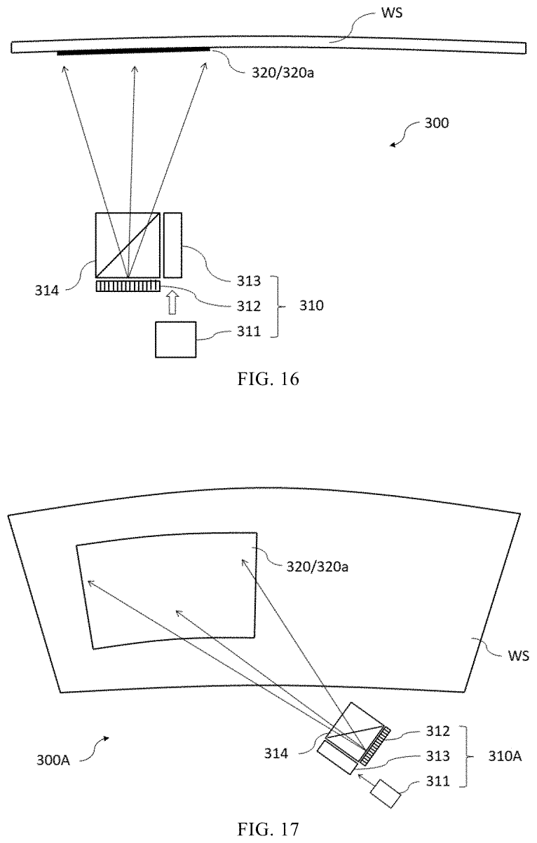

FIG. 16 is a schematic diagram of a HUD system 300 according to the third embodiment of the present invention. The HUD system 300 according to the third embodiment of the present invention is substantially the same in structure as the HUD system according to the first embodiment of the present invention, in which a diffuser arranged along an optical path between a coherent light source and an image modulator is also used as a light diffusing device. The major difference between both is that the image modulator in the HUD system 300 is formed using an LCOS.

As shown in FIG. 16, the HUD system 300 comprises an optical engine 310 and a diffractive projection screen 320, wherein the optical engine 310 includes a coherent light source 311, an LCOS 312 used as an image modulator, and a diffuser 313, as a light diffusing device, arranged on an optical path between the coherent light source 311 and the LCOS 312. Since the LCOS is a reflection-type device, the optical engine 310 may also include an optical device for integrating optical paths, for example, a polarizing beam splitting prism (PBS) 314 as shown in the drawing. The diffractive projection screen 320 may be formed using the diffractive projection screen described above with reference to the first embodiment, and will not be described any more here.

Light emitted by the coherent light source 311 enters the diffuser 313 (the way of entering the diffuser 313 from the side by means of irradiation, as shown in the drawing, is not restrictive, but illustrative only). Upon the diffusion effect made by the diffuser 313, the light with a divergent spatial angular distribution is emergent from the light emergent surface of the diffuser 313, and such light is illuminated onto the surface of the LCOS after, for example, the reflection of the PBS and then modulated by the LCOS to form a light spatial distribution corresponding to the target image. In the HUD system 300, the display surface of the optical engine 310 is formed on the light emergent surface of the LCOS. The light with the divergent spatial angular distribution corresponding to each pixel on the display surface of the optical engine 310 is projected towards the diffractive projection screen 320, and is formed into a magnified virtual image of the target image upon the diffraction effect of the diffractive projection screen 320.

FIG. 17 shows another possible arrangement of the HUD system shown in FIG. 16. As shown in the drawing, projection towards the diffractive projection screen can be enabled by adjusting the “posture” of the optical engine 310A relative to the diffractive projection screen 320.

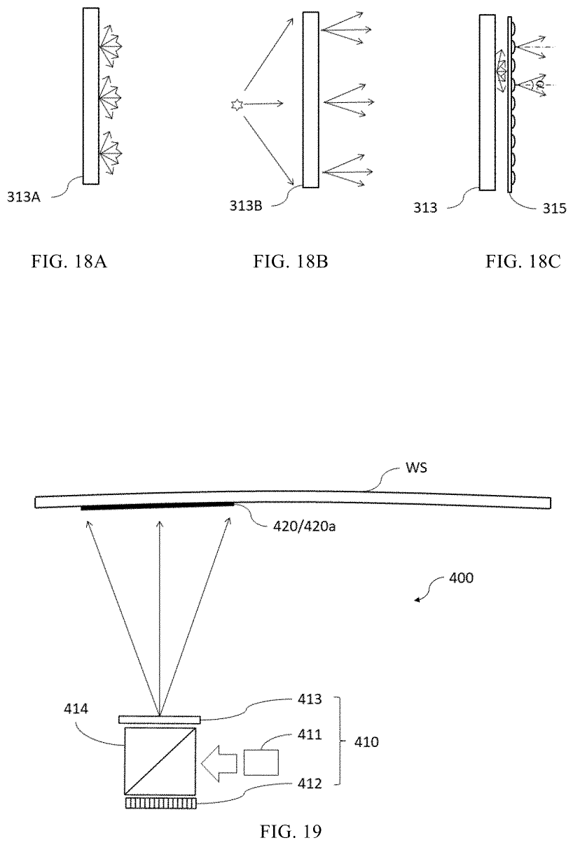

The diffuser 313 in the HUD system shown in FIGS. 16 and 17 may be formed using, for example, a diffuser 313A capable of providing, for example, an approximate Lambertian light source, as shown in FIGS. 18A and 18B; or a diffuser 313B capable of providing a “directional” light source with a limited divergence angle, as shown in FIG. 18B. Such a diffuser 313B may include at least one of, for example, an aperture array, a micro mirror array, a micro prism array, a micro lens array, a grating, a HOE, a CGH and a DOE. In addition, similar to the discussed above with reference to the variant of the first embodiment, the diffuser 313 may also be used along with a directional projecting device 315 capable of limiting the divergence angle of a light beam. In the HUD system according to the third embodiment of the present invention, the directional projecting device 315 is preferably arranged between the diffuser 313 and the LCOS 312.

### The Fourth Embodiment and a Variant Thereof

FIG. 19 shows a schematic diagram of a HUD system according to the fourth embodiment of the present invention. The HUD system 400 according to the fourth embodiment of the present invention is substantially the same in structure as the HUD system according to the third embodiment of the present invention, in which an LCOS is also used as an image modulator. The major difference between both is that the optical diffusing device in the HUD system 400 is formed using a diffusing screen arranged downstream of the LCOS.

Specifically, as shown in FIG. 19, the HUD system 400 comprises an optical engine 410 and a diffractive projection screen 420, wherein the optical engine 410 includes a coherent light source 411, an LCOS 412 used as an image modulator, and a diffusing screen 413, as a light diffusing device, arranged on an optical path downstream of the LCOS 412. Since the LCOS is a reflection-type device, the optical engine 410 may also include an optical device for integrating optical paths, for example, a polarizing beam splitting prism (PBS) 414.

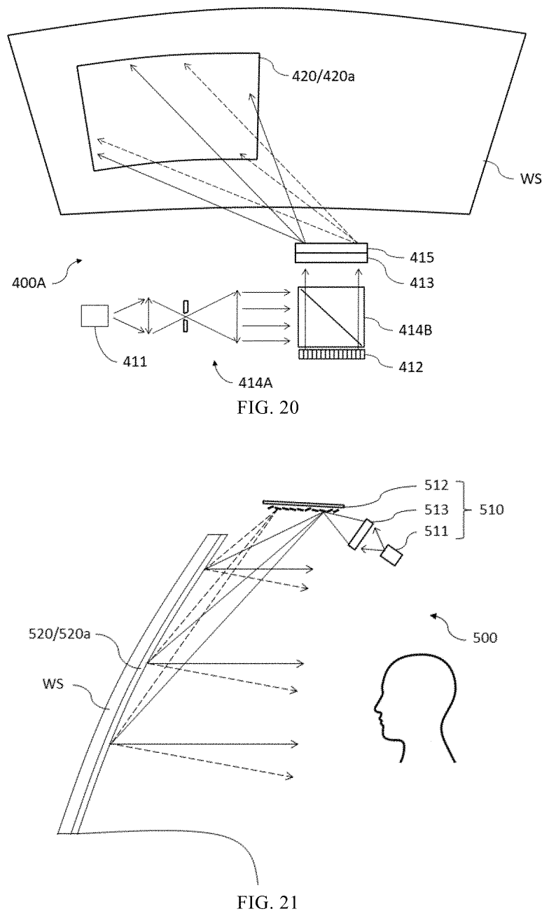

Light emitted by the coherent light source 411 enters the PBS 414, and, after being reflected by the PBS 414, illuminates onto the surface of the LCOS 412. In order to better illuminate the whole surface of the LCOS, a beam expander (e.g., the beam expander 414A shown in FIG. 20), for example, may be arranged between the coherent light source 411 and the LCOS 412, and the beam expander preferably has the function of collimation. Upon the modulation by the LCOS 412, a light spatial distribution corresponding to the target image is formed. The LCOS generally does not change the direction of the light that passes through the same, and therefore the diffusing screen 413 receives light, as modulated by the LCOS 412, having a spatial distribution corresponding to the target image, and diffuses the light corresponding to each pixel into light with a divergent spatial angular distribution. In the HUD system 400, the display surface of the optical engine 410 is formed on the light emergent surface of the diffusing screen 413. The light with the divergent spatial angular distribution corresponding to each pixel emitted from the display surface of the optical engine 410 is projected towards the diffractive projection screen 420, and is formed into a magnified virtual image of the target image upon the diffraction effect of the diffractive projection screen 420.

The diffusing screen 413 may be formed using the diffusing screen described with reference to the HUD system 200 according to the second embodiment of the present invention, and will not be described any more here.

FIG. 20 shows a HUD system 400A according to a variant of the fourth embodiment of the present invention. As compared with the HUD system 400 shown in FIG. 19, a directional projecting device 415 is further incorporated into the HUD system 400A, which is arranged downstream of the diffusing screen 413. The directional projecting device 415 may be formed using, for example, a directional projecting device the same as or similar to the one used in the HUD system according to a variant of the first embodiment of the present invention.

### The Fifth Embodiment and a Variant Thereof

FIG. 21 is a schematic diagram of a HUD system 500 according to the fifth embodiment of the present invention. The HUD system 500 according to the fifth embodiment of the present invention is substantially the same in structure as the HUD system according to the first embodiment of the present invention, in which a diffuser arranged along an optical path between a coherent light source and an image modulator is also used as a light diffusing device. The major difference between both is that the image modulator in the HUD system 500 is formed using a digital micromirror device (DMD).

As shown in FIG. 21, the HUD system 500 comprises an optical engine 510 and a diffractive projection screen 520. The optical engine 510 includes a coherent light source 511, a DMD 512 used as an image modulator, and a diffuser 513 arranged between the coherent light source 511 and the DMD 512. In some examples, the diffuser 513 may be formed in the form of a light guide plate, which, for example, receives light from the coherent light source 511 from the side or back. In another example, the optical engine 510 may also optionally include a beam expander (not shown) between the coherent light source 511 and the diffuser 513 for expanding beams of the light from the coherent light source 511, and preferably further performing collimation to better illuminate the diffuser 513. The diffractive projection screen 520 may be formed using the diffractive projection screen described above with reference to the first embodiment, and will not be described any more here.

Light emitted by the coherent light source 511 enters the diffuser 513. Upon the diffusion effect made by the diffuser 513, the light with a divergent spatial angular distribution is emergent from the light emergent surface of the diffuser 513. Such light is illuminated onto the surface of the DMD 512 and then modulated by the DMD 512 to form a light spatial distribution corresponding to the target image. In the HUD system 500, the display surface of the optical engine 510 is formed on the light emergent surface of the DMD 512. The light with the divergent spatial angular distribution corresponding to each pixel emitted from the display surface of the optical engine 510 is projected towards the diffractive projection screen 520, and is formed into a magnified virtual image of the target image upon the diffraction effect of the diffractive projection screen 520.

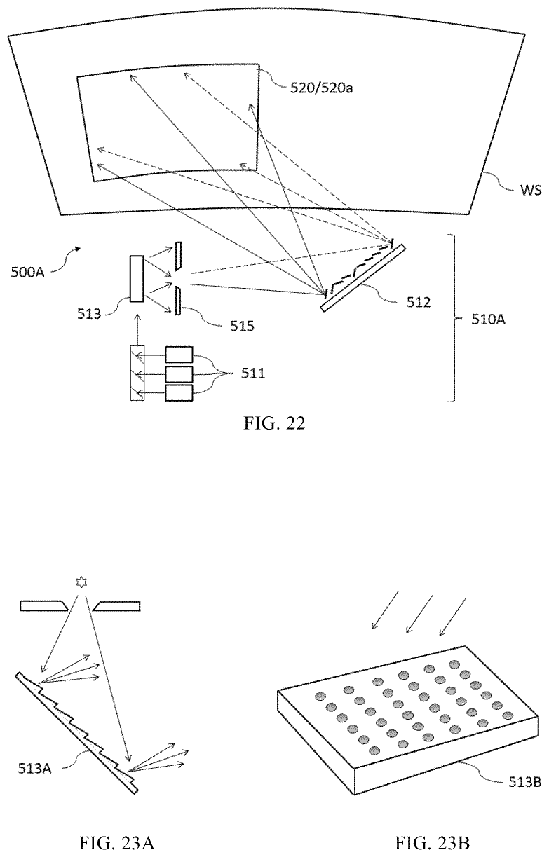

FIG. 22 shows a HUD system 500A according to a variant of the fifth embodiment of the present invention. The HUD system 500A is substantially the same in structure as the HUD system 500 shown in FIG. 21. The major difference between both is that a directional projecting device 515 is further incorporated into the HUD system 500, which is arranged between the diffuser 513 and the DMD 512. In the illustrated example, the directional projecting device 515 includes an aperture; however, it should be understood that the directional projecting device may also be in other forms. In addition, by comparing the HUD systems shown in FIGS. 21 and 22, it can be found that the optical engine may be mounted at different positions. For example, FIG. 21 shows that the optical engine 510 may be mounted on, for example, the roof of an automobile; while FIG. 22 shows that the optical engine 510A may be mounted at a position below the windshield WS, for example, at the top of the automobile dashboard.

FIGS. 23A and 23B schematically show examples of a light diffusing device that can be used in the HUD systems shown in FIGS. 21 and 22, which can be used as a diffuser or as a diffusing screen. FIG. 23A shows a light diffusing device 513A composed of, for example, a grating; and FIG. 23B shows a light diffusing device 513B composed of, for example, a micro mirror array. Certainly, what is shown in FIG. 23 is illustrative only, instead of acting as limitations.

### The Sixth Embodiment

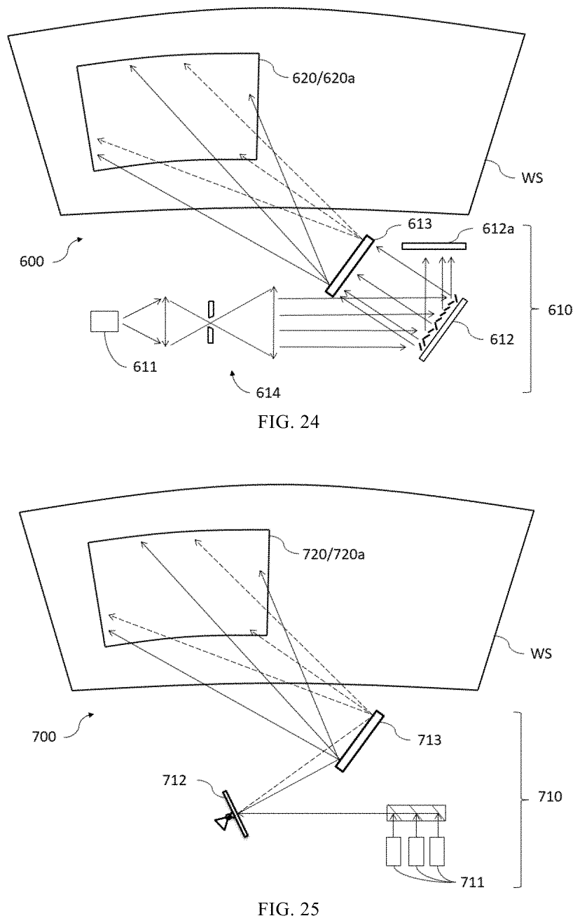

FIG. 24 shows a HUD system 600 according to the sixth embodiment of the present invention. The HUD system 600 according to the sixth embodiment of the invention is substantially the same in structure as the HUD system according to the fifth embodiment of the invention, in which a DMD is also used as an image modulator. The major difference between both is that the light diffusing device in the HUD system 600 is formed using a diffusing screen arranged downstream of the DMD.

As shown in FIG. 24, the HUD system 600 comprises an optical engine 610 and a diffractive projection screen 620, wherein the optical engine 610 includes a coherent light source 611, a DMD 612 used as an image modulator, and a diffusing screen 613, as a light diffusing device, arranged on an optical path downstream of the DMD 612. Optionally, a beam expander 614 may be arranged between the coherent light source 611 and the DMD 612 for better illuminating the whole surface of the DMD. The beam expander 614 preferably further has the function of collimation.

Light emitted by the coherent light source 611 illuminates onto the surface of the DMD 612 after being expanded and collimated by, for example, the beam expander 614. Upon the modulation made by the DMD 612, a light spatial distribution corresponding to the target image is formed. The DMD generally does not change the direction of the light that passes through the same, and therefore the diffusing screen 613 receives light, as modulated by the DMD 612, having a spatial distribution corresponding to the target image, and diffuses the light corresponding to each pixel into light with a divergent spatial angular distribution. The reference sign 612a in the drawing denotes a light absorption plate in the DMD 612, which is used for absorbing reflected light not used for imaging. In the HUD system 600, the display surface of the optical engine 610 is formed on the light emergent surface of the diffusing screen 613. The light with the divergent spatial angular distribution corresponding to each pixel emitted from the display surface of the optical engine 610 is projected towards the diffractive projection screen 620, and is formed into a magnified virtual image of the target image upon the diffraction effect of the diffractive projection screen 620.

It should be understood that the diffusing screen 613 may be formed using the diffusing screen described with reference to the HUD system 200 according to the second embodiment of the present invention; in addition, a directional projecting device arranged downstream of the diffusing screen may be further incorporated into the HUD system according to the sixth embodiment of the present invention, which is similar to those discussed in the previous embodiments and variants.

### The Seventh Embodiment and a Variant Thereof

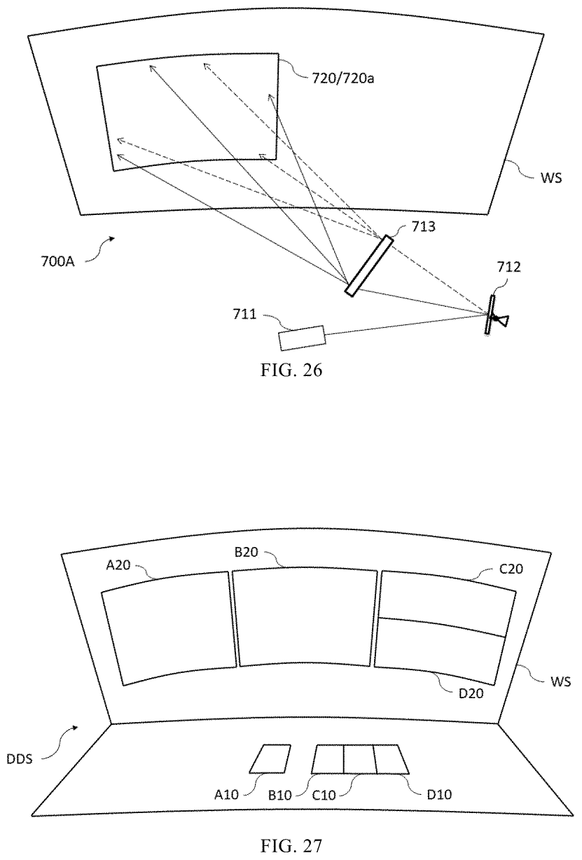

In all of the HUD systems according to the first to the sixth embodiments of the present invention described above with reference to the drawings, a spatial light modulator (SLM) is used as an image modulator; however, the present invention is not limited to the case where the SLM is used. For example, HUD systems according to the seventh embodiment of the present invention and a variant thereof will be described below with reference to FIGS. 25 and 26, in which the image modulator includes a scanning galvanometer.

FIG. 25 is a schematic diagram of a HUD system according to the seventh embodiment of the present invention. In the HUD system according to the present embodiment, the image modulator includes a scanning galvanometer, and a diffusing screen arranged on an optical path downstream of the scanning galvanometer is used as a light diffusing device.

As shown in FIG. 25, the HUD system 700 comprises an optical engine 710 and a diffractive projection screen 720, wherein the optical engine 710 includes a coherent light source 711, a scanning galvanometer 712, and a diffusing screen 713 arranged in turn along an optical path. According to the embodiment, the image modulator includes a scanning galvanometer 713, and may also include a light source modulator (not shown) combined in, for example, the coherent light source 711, which modulates light output by the coherent light source 711, including, for example, the intensity of the light and/or the wavelength (color) of the light, in a time sequence.

Light output from the coherent light source 711 and modulated in respect of, for example, light intensity/color in a time sequence is illuminated onto the scanning galvanometer 712, and the scanning galvanometer 712 reflects the light at different angles corresponding to the time sequence of the light source modulator, so as to form a light spatial distribution corresponding to the target image. The light output from the scanning galvanometer 712 and having the light spatial distribution corresponding to the target image is illuminated onto the diffusing screen 713, and the diffusing screen 713 diffuses the light corresponding to each pixel into light with a divergent spatial angular distribution. In the HUD system 700, the display surface of the optical engine 710 is formed on the light emergent surface of the diffusing screen 713. The light with the divergent spatial angular distribution corresponding to each pixel emitted from the display surface of the optical engine 710 is projected towards the diffractive projection screen 720, and is formed into a magnified virtual image of the target image upon the diffraction effect of the diffractive projection screen 720.

FIG. 26 shows a HUD system 700A according to a variant of the seventh embodiment of the present invention. The HUD system 700A is substantially the same in structure as the HUD system 700 shown in FIG. 25. The major difference between both is that a reflection-type diffusing screen 513 is used in the former, while a transmission-type diffusing screen 513A is used in the latter.

The HUD systems according to the embodiments of the present invention are described above with reference to the drawings. Although all of the diffractive projection screens are reflection-type in the HUD systems shown in the drawings and discussed above, the present invention is not limited to this. According to the service environment of a HUD system, a transmission-type diffractive projection screen may also be used according to needs.

According to another aspect of the present invention, a multi-screen joined diffraction display system is further provided. The diffraction display system is based on the same single-screen display principle and configuration as the HUD system according to the embodiments of the present invention, and can achieve the continuity of images among different screens at the same time. The multi-screen joined diffraction display system is especially suitable for use as a HUD system, but can also be applied in other occasions. For the convenience of understanding, a multi-screen joined diffraction display system according to the eighth embodiment of the present invention will be described below taking the HUD system as an example with reference to FIGS. 27 to 30.

### The Eighth Embodiment

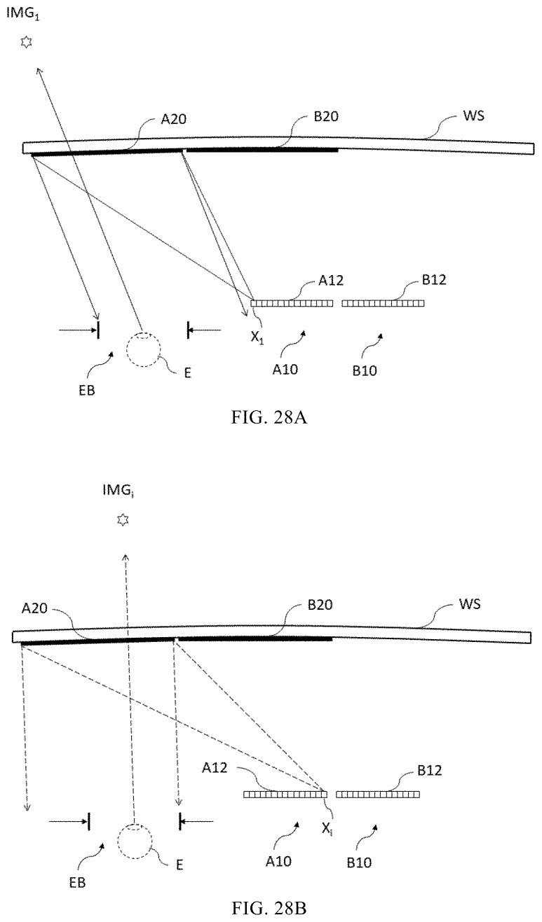

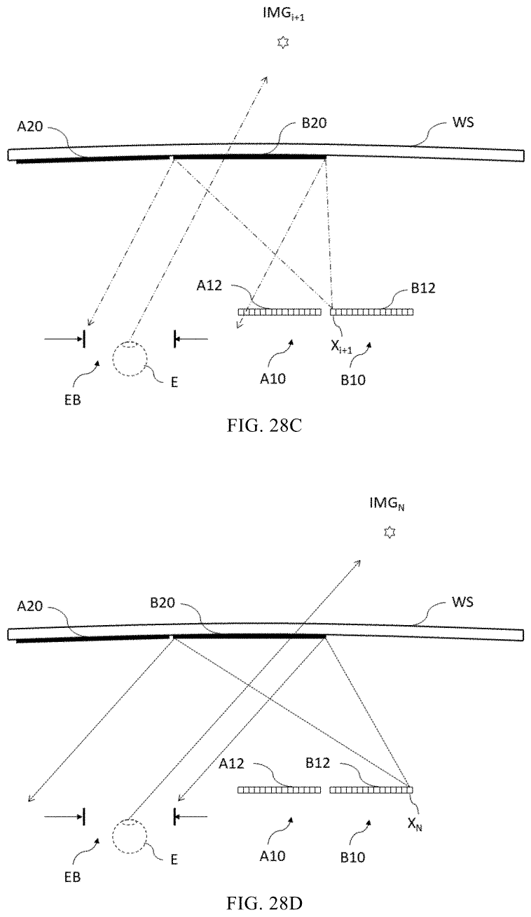

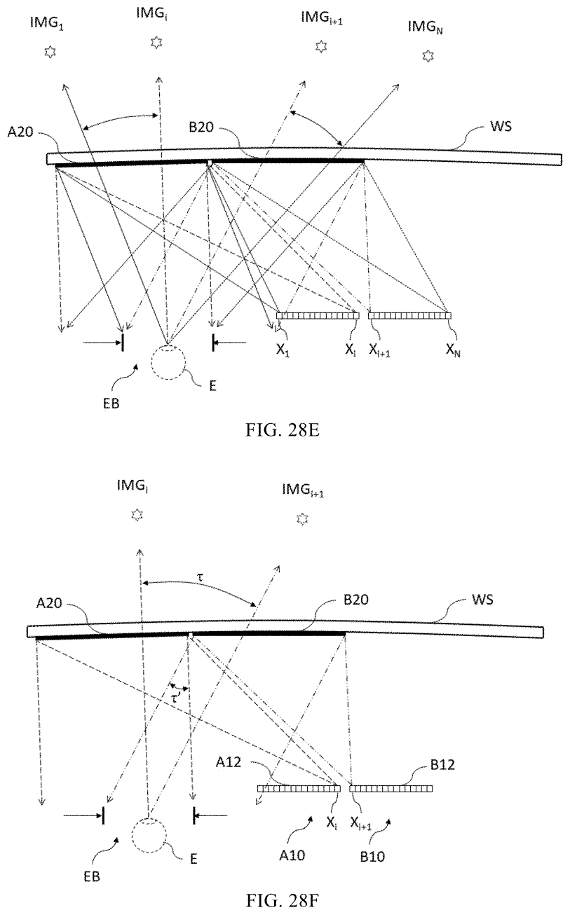

First, a multi-screen system comprising a plurality of HUD systems and possible problems that may exist therein will be explained with reference to FIGS. 27 and 28.

FIG. 27 schematically shows a diffraction display system DDS, comprising, for example, a plurality of display subsystems A, B, C and D composed of a HUD system according to the first to seventh embodiments of the present invention. The display subsystems A, B, C and D each include optical engines A10, B10, C10 and D10 and corresponding diffractive projection screens A20, B20, C20 and D20.

Each of the optical engines A10, B10, C10 and D10 has a display surface for outputting a target image respectively. Each optical engine includes a laser light source, an image modulator that modulates light emitted by the laser light source to obtain a light spatial distribution corresponding to the target image, and a light diffusing device arranged on an optical path from the laser light source to the display surface and used for diffusing light, causing the light beams emitted by each pixel on the display surface to be divergent.

The diffractive projection screens A20, B20, C20 and D20 are adjacent to each other and each comprise a diffractive optical device for forming virtual images of the target images output by the first optical engine and the second optical engine respectively; the projection region of the light beams emitted by each pixel on the display surfaces of the first optical engine or the second optical engine on the corresponding diffractive projection screen at least partially overlaps with the projection region of the light beams emitted by a plurality of other pixels on the same display surface on the same diffractive projection screen.

FIGS. 28A to 28F illustrate, by taking two display subsystems A and B therein as an example, the possible imaging issues that may occur when a diffraction display system DDS shown in FIG. 27 includes two independent display subsystems.

As shown in FIG. 28, in order to form a distant and magnified virtual image of the target image to make it easy for users to view the image, the diffractive projection screens A20 and B20 each can diffract light from each pixel on the display surfaces (shown in the drawing is the surface of the image modulator) A12, B12 of the corresponding optical engines A10 and B10 to form parallel or approximately parallel imaging beams, and enable the projection directions of the imaging beams corresponding to different pixels to be different from each other. As shown in FIGS. 28A and 28B, a light beam from pixel X₁ at one end of the display surface A12 (actually in a direction perpendicular to the drawing surface, there may be a column of multiple pixels on the display surface, and only one pixel is discussed as an example herein) is projected onto the diffractive projection screen A20 and then formed into a parallel or approximately parallel imaging beam; and a light beam from pixel Xᵢ at the other end, opposite to the one end, of the display surface A12 is projected onto the diffractive projection screen A20 and then formed into another parallel or approximately parallel imaging beam. The two parallel beams are formed at different angles, such that virtual images IMG₁ and IMGᵢ can be observed by an observer's eye E. Similarly, as shown in FIGS. 28C and 28D, a light beam from pixel Xᵢ₊₁ at one end of the display surface B12 is projected onto the diffractive projection screen B20 and then formed into a parallel or approximately parallel imaging beam; and a light beam from pixel X_{N} at the other end, opposite to the one end, of the display surface B12 is projected onto the diffractive projection screen B20 and then formed into another parallel or approximately parallel imaging beam. The two parallel beams are formed at different angles, such that virtual images IMGᵢ₊₁ and IMG_{N} can be observed by the observer's eye E.

In consideration of the size of the design window EB of a display system, in order to ensure that the virtual image can be observed by the eye E at any position in the design window EB, in terms of each display subsystem, a light beam from any pixel of the display surface thereof is diffracted by the diffractive projection screen to form an imaging beam that is expected to fill the whole design window EB. For this purpose, in a boundary case, as shown in FIG. 28, an edge of the imaging beam corresponding to the edge pixels X₁, Xᵢ, Xᵢ₊₁ and X_{N} of the display surfaces A12 and B12 passes through a corresponding boundary of the design window.

The display subsystems A and B can form continuous virtual images respectively. However, when both are combined together, the images displayed by them are discontinuous. To explain this case, FIG. 28E shows the superposition of the imaging beams shown in FIGS. 28A to 28D. As can be seen, even though the display surfaces A12 and B12 of the display subsystems A and B display continuable images, that is, the pixels Xᵢ and Xᵢ₊₁ display the contents of two immediately adjacent pixels in a continuous image, since the obtained virtual images IMGᵢ and IMGᵢ₊₁ have a large visual angle difference τ relative to the eye E (see FIG. 28F) in order to meet the requirements of the design window, the images displayed by the display subsystems A and B are not continuous as observed by the user. The aforesaid visual angle difference τ is approximately equal to an opening angle τ′ of the design window EB relative to the adjacent edges of the diffractive projection screen A20 and B20. Therefore, the larger a desired design window, the more significant the aforesaid discontinuity in an image.

In order to improve the display quality, a diffractive optical device (such as hologram, DOE, HOE, etc.) of a diffractive projection screen may be configured by using more precise and complicated methods sometimes. However, the difficulties in manufacturing such diffractive optical device will become significantly greater with the increase of the size of the diffractive optical device. Or, to put it another way, when the size of a single diffractive projection screen increases a lot, it is likely that the display quality will decrease accordingly.

Given the aforesaid problems, a multi-screen joined diffraction display system is provided according to the eighth embodiment of the present invention, which comprises at least two display subsystems, wherein diffractive projection screens of the two display subsystems are adjacent to each other, and images displayed by the two display subsystems are continuous for an observer.

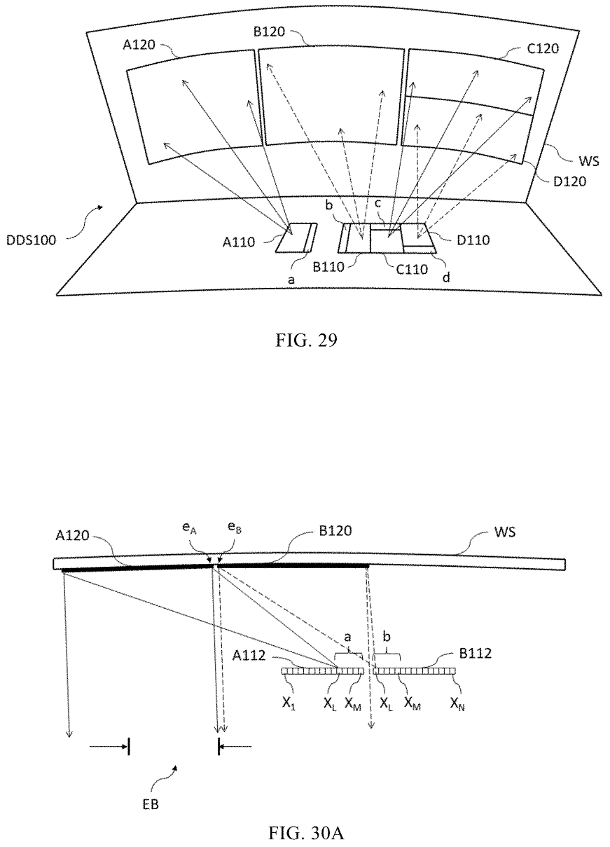

FIG. 29 shows an example of a multi-screen joined diffraction display system according to the eighth embodiment of the present invention. The display system DDS100 comprises a plurality of display subsystems A, B, C and D, and the display subsystems A, B, C and D each comprise optical engines A110, B110, C110 and D110 and corresponding diffraction projection screens A120, B120, C120 and D120.

The multi-screen joined diffraction display system DDS100 has substantially the same structure as the display system DDS described above with reference to FIG. 27, while they mainly differ in that: in the system DDS100, the image modulators A112, B112, C112 and D112 in the optical engines of the display subsystems each have an edge portion a, b, c and d containing one side edge thereof, and two of the edge portions in two display subsystems to be joined with each other, for example, the edge portion a and the edge portion b (or the edge portion c and the edge portion d), are used to display the same content; and that imaging beams of pixels corresponding to each other in the two edge portions a and b generated by respective diffraction by the corresponding diffractive projection screens are parallel to each other.

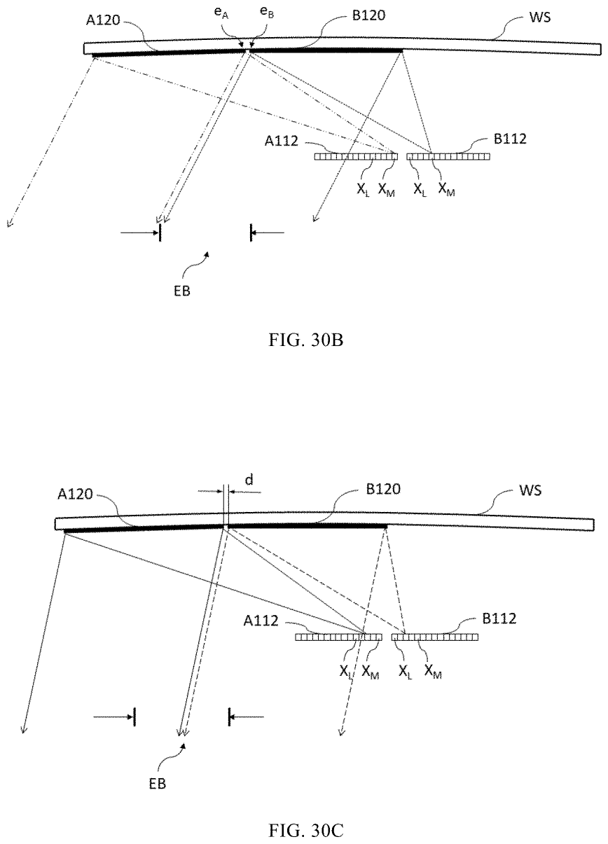

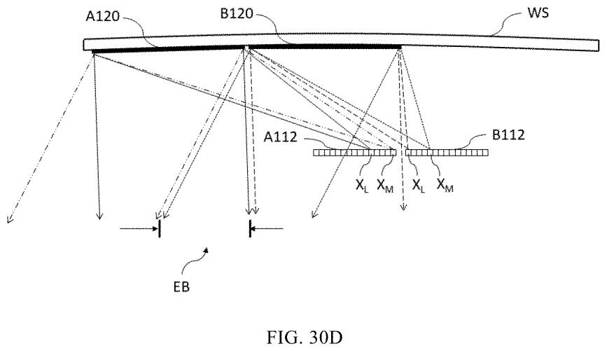

Next, more detailed description of the imaging by the multi-screen joined diffraction display system DDS100 will be made taking the display subsystems A and B as an example with reference to FIG. 30.

As shown in FIG. 30A, the image modulator A112 has an edge portion a spanning several pixels at the right edge thereof (corresponding to the position of pixel X_{M}), the image modulator B112 has an edge portion b spanning several pixels at the left edge thereof (corresponding to the position of pixel XL), and the edge portion a and the edge portion b are used to display the same content; in other words, both are used as the same pixels X_{L}˜X_{M}.

According to the embodiment, as shown in FIGS. 30A and 30B, the pixels XL corresponding to each other in the edge portions a and b are respectively diffracted by the diffractive projection screens A120 and B120 to form imaging beams (the beams respectively shown in solid line and broken line in FIG. 30A) that are parallel to each other. Similarly, the pixels X_{M} corresponding to each other in the edge portions a and b are respectively diffracted by the diffractive projection screens A120 and B120 to form imaging beams (the beams respectively shown in dot dash line and dot line in FIG. 30B) that are parallel to each other. Certainly, other pixels located between the pixels X_{L} and X_{M} in the edge portions a and b also meet the above requirements in respect of parallel imaging beams, as shown in FIG. 30C. In this way, the images displayed by the two display subsystems can be made continuous relative to each other.

In addition, given the design window EB, a further requirement is raised for the width of the edge portions a and b (or the range of the pixels X_{L}˜X_{M} spanned by them). Still by referring to FIGS. 30A and 30B, light emitted by the pixel X_{M} in the edge portion a of the image modulator A12 is diffracted at the first edge e_{A} of the diffractive projection screen A120 to form a light beam that passes through a first boundary of the design window EB of the multi-screen joined diffraction display system (see FIG. 30A), and light emitted by the pixel X_{L} of the edge portion b of the image modulator B112 is diffracted at the second edge e_{B} of the diffractive projection screen B120 to form a light beam that passes through a second boundary, opposite to the first boundary, of the design window of the multi-screen joined diffraction display system. FIG. 30D illustrates the superposition of the imaging beams shown in FIGS. 30A and 30B. It can be seen in a more clear manner from FIG. 30D that with regard to the display subsystem A, the imaging beams corresponding to the pixels, from the pixel X_{L} to the pixel X_{M} of the image modulator A112, gradually exit from the design window EB; and with regard to the display subsystem B, the imaging beams corresponding to the pixels, from the pixel X_{L} to the pixel X_{M} of the image modulator B112, gradually enter into the design window EB, and fill or almost fill the whole design window EB right together with the imaging beams of the corresponding pixels in the display subsystem A. With reference to FIG. 30C, the unfilled portion of the window is mainly determined by the gap d between the first edge e_{A} of the diffractive projection screen A120 and the second edge e_{B} of the diffractive projection screen B120. Therefore, in one preferred embodiment, the width of the gap d is less than or equal to 2 mm (the lower limit of the average pupil diameter of human), and it is more preferred that the two diffractive projection screens are seamlessly joined (for example, the diffractive projection screens C120 and D120 shown in FIG. 29), namely, the gap d=0.

It can be seen that, by this, the predetermined widths of the edge portions a and b of the image modulators A112 and B112 in the direction perpendicular to the side edges of the image modulators contained by them correspond to (or at least partially determine) the width of the actually obtained window of the multi-screen joined diffraction display system. Generally, an actually obtained window width is expected to be no less than the width of the design window EB. In some embodiments, when the width of the design window EB is determined, the predetermined width of the edge portion of the image modulator may be selected to correspond to the width of the design window EB.

Now reference is made back to FIG. 29. The “joined” display subsystems A and B achieved by the edge portions for displaying the same content in the image modulators have been described above referring to FIG. 30. Similarly, as shown in FIG. 29, the display subsystems C and D may also be “joined” by arranging the edge portions c and d for displaying the same content in their image modulators and making them meet other conditions described above with reference to FIG. 30.

In some examples, the optical engines of two “joined” display subsystems may be arranged in such a manner as to enable the side edges contained in the edge portions of their image modulators to be opposite to each other, for example the case of the display subsystems A and B.

In some examples, the image modulators of the optical engines of two or more display subsystems, for example, the display subsystems B, C and D shown in FIG. 29, may be integrated into one, especially when the directional projecting device provided according to the embodiments of the present invention is combined for use.

In some examples, the optical engines of two or more display subsystems may share the laser light source and/or the light diffusing device.

In some examples, the optical engines of two “joined” display subsystems may be arranged to be spatially distant from each other, for example, the optical engines A110 and B110 shown in FIG. 29.

Preferably, the optical engine of each display subsystem only projects the output target image onto the corresponding diffractive projection screen. In some preferred examples, the light diffusing device in the optical engine of the display subsystem may be further configured in such a manner as to enable a light beam emitted therefrom corresponding to each pixel to have a specific spatial angular distribution, such that the light energy is concentrated for projection towards the diffractive projection screen. In some preferred examples, the optical engine may further include a directional projecting device arranged downstream of the light diffusing device along an optical path from the laser light source to the display surface, and the directional projecting device is configured to limit a divergence angle of the light beam emitted therefrom corresponding to each pixel and/or change a direction of the center light of the light beams to enable the light beams to have a specific spatial angular distribution, such that the light energy is concentrated for projection towards the diffractive projection screen. In short, one or more display subsystems in a multi-screen joined diffraction display system according to an embodiment of the present invention may have a configuration as described above in connection with the first to the seventh embodiments of the present invention and the variants thereof, including to comprise a light diffusing device and a directional projecting device therein. The difference is that the multi-screen joined diffraction display system and the display subsystems thereof are not limited to a HUD system.

In addition, it should be understood that although the display system DDS100 is shown in the drawing to include four display subsystems, the present invention is not limited to this, and the multi-screen joined diffraction display system according to the embodiments of the present invention may include more or less display subsystems in number.

Described above are only the better embodiments of the present application and an explanation of the adopted technical principles. Those skilled in the art should understand that the invention scope referred to in the present application is not limited to the technical solutions formed by the specific combination of the above technical features, but also should cover other technical solutions concluded by the arbitrary combination of the aforesaid technical features or the equivalents without departing from the inventive concept, for example, the technical solutions reached by means of replacing the aforesaid features with the technical features having similar functions disclosed in the present application (but not limited to so).

1. A head-up display (HUD) system, comprising:
an optical engine for outputting a target image on a display surface of the optical engine, the optical engine comprising a coherent light source, an image modulator that modulates light emitted by the coherent light source to obtain a light spatial distribution corresponding to the target image, and a light diffusing device arranged on an optical path from the coherent light source to the display surface and used for diffusing light and causing the light beams emitted by each pixel on the display surface to be divergent; and
a diffractive projection screen comprising a diffractive optical device for forming a virtual image of the target image by diffracting the light from the optical engine, wherein a projection region of the light beams emitted by each pixel on the display surface on the diffractive projection screen at least partially overlaps projection regions of the light beams emitted by a plurality of other pixels on the diffractive projection screen.

2. The HUD system according to claim 1, wherein the coherent light source is a laser light source.

3. The HUD system according to claim 1, wherein the projection region of the light beams emitted by each pixel on the display surface on the diffractive projection screen substantially covers the whole diffractive projection screen.

4. The HUD system according to claim 1, wherein the diffractive projection screen diffracts light from each pixel on the display surface to form parallel or approximately parallel imaging beams, and the projection directions of the imaging beams corresponding to different pixels are different from each other.

5. The HUD system according to claim 4, wherein the diffractive optical device comprises at least one of a holographic film, a CGH, a HOE and a DOE.

6. The HUD system according to claim 5, wherein the diffractive optical device comprises a monolayered or a multilayered structure used for different wavelengths.

7. The HUD system according to claim 1, wherein the image modulator comprises a spatial light modulator, the light diffusing device comprises a diffuser arranged upstream of the spatial light modulator along the optical path from the coherent light source to the display surface, and the display surface is formed on the spatial light modulator.

8. The HUD system according to claim 7, wherein the image modulator is an LCD, and the coherent light source and the diffuser constitute a backlight assembly for the LCD.

9. The HUD system according to claim 1, wherein the image modulator comprises a spatial light modulator, the light diffusing device comprises a diffusing screen arranged downstream of the spatial light modulator along the optical path from the coherent light source to the display surface, and the display surface is formed on the diffusing screen.

10. The HUD system according to claim 9, wherein the optical engine further comprises a beam expander arranged between the coherent light source and the image modulator and used for expanding light from the coherent light source to illuminate the whole incident surface of the image modulator.

11. The HUD system according to claim 10, wherein the beam expander collimates the light from the coherent light source to obtain substantially collimated light beams to illuminate the image modulator.

12. The HUD system according to claim 7, wherein the image modulator is an LCD, an LCOS or a DMD.

13. The HUD system according to claim 1, wherein the image modulator comprises a scanning galvanometer, the light diffusing device comprises a diffusing screen arranged downstream of the scanning galvanometer along the optical path from the coherent light source to the display surface, and the display surface is formed on the diffusing screen.

14. The HUD system according to claim 1, wherein the light diffusing device comprises a scattering element, a micro mirror array, a micro prism array, a micro lens array, a HOE, a CGH, a DOE, or a combination thereof.

15. The HUD system according to claim 1, wherein the light diffusing device is further configured to adjust light beams emitted therefrom corresponding to each pixel to have a specific spatial angular distribution, such that the light energy is concentrated for projection towards the diffractive projection screen.

16. The HUD system according to claim 15, wherein center light of the light beams emitted by the light diffusing device corresponding to each pixel deviates from a direction perpendicular to the light diffusing device.

17. The HUD system according to claim 15, wherein the light diffusing device comprises at least one of an aperture array, a micro mirror array, a micro prism array, a micro lens array, a grating, a HOE, a CGH and a DOE.

18. The HUD system according to claim 1, wherein the optical engine further comprises a directional projecting device arranged downstream of the light diffusing device along the optical path from the coherent light source to the display surface, and the directional projecting device is configured to limit a divergence angle of light beams emitted therefrom corresponding to each pixel and/or change a direction of center light of the light beams to enable the light beams to have a specific spatial angular distribution, such that the light energy is concentrated for projection towards the diffractive projection screen.

19. The HUD system according to claim 18, wherein the center light of the light beams emitted by the directional projecting device corresponding to each pixel deviates from a direction perpendicular to the directional projecting device.

20. The HUD system according to claim 18, wherein the directional projecting device is arranged upstream of the image modulator along the optical path from the coherent light source to the display surface, and the display surface is formed on the image modulator; or
the directional projecting device is arranged downstream of the image modulator along the optical path from the coherent light source to the display surface, and the display surface is formed on the directional projecting device.

21. The HUD system according to claim 18, wherein the directional projecting device comprises an aperture array, a micro mirror array, a micro prism array, a micro lens array, a grating, a HOE, a CGH, a DOE, or a combination thereof.

22. A multi-screen joined diffraction display system, comprising:
a first optical engine and a second optical engine, each having a display surface for outputting a target image, the first optical engine and the second optical engine each comprising a laser light source, an image modulator that modulates light emitted by the laser light source to obtain a light spatial distribution corresponding to the target image, and a light diffusing device arranged on an optical path from the laser light source to the display surface and used for diffusing light and causing the light beams emitted by each pixel on the display surface to be divergent; and
a first diffractive projection screen and a second diffractive projection screen, adjacent to each other and each comprising a diffractive optical device for forming virtual images of the target images output by the first optical engine and the second optical engine respectively, a first edge of the first diffractive projection screen and a second edge of the second diffractive projection screen being opposite and adjacent to each other, the projection region of the light beams emitted by each pixel on the display surfaces of the first optical engine and the second optical engine on the corresponding diffractive projection screen at least partially overlapping the projection region of the light beams emitted by a plurality of other pixels on the same display surface on the same diffractive projection screen,
wherein an edge portion of the image modulator of the first optical engine comprising a first side edge thereof and an edge portion of the image modulator of the second optical engine comprising a second side edge thereof are used to display the same content, and imaging beams formed by diffracting pixels corresponding to each other in the two edge portions respectively through the first diffractive projection screen and the second diffractive projection screen are parallel to each other.

23. The multi-screen joined diffraction display system according to claim 22, wherein the first diffractive projection screen and the second diffractive projection screen diffract light from each pixel on the corresponding display surface to form parallel or approximately parallel imaging beams, and the projection directions of the imaging beams corresponding to different pixels are different from each other.

24. The multi-screen joined diffraction display system according to claim 22, wherein the projection region of the light beams emitted by each pixel on the display surface on the corresponding diffractive projection screen substantially covers the whole diffractive projection screen.

25. The multi-screen joined diffraction display system according to claim 22, wherein the edge portions of the image modulators of the first optical engine and the second optical engine have a predetermined width in a direction perpendicular to the first side edge and the second side edge respectively, and the predetermined width corresponds to the width of a design window of the multi-screen joined diffraction display system.

26. The multi-screen joined diffraction display system according to claim 25, wherein light emitted by a pixel at the first side edge of the image modulator of the first optical engine is diffracted at the first edge of the first diffractive projection screen to form light beams that pass through a first boundary of the design window of the multi-screen joined diffraction display system, and light emitted by a pixel at the second side edge of the image modulator of the second optical engine is diffracted at the second edge of the second diffractive projection screen to form light beams that pass through a second boundary, opposite to the first boundary, of the design window of the multi-screen joined diffraction display system.

27. The multi-screen joined diffraction display system according to claim 25, wherein the first optical engine and the second optical engine are arranged to adjust the first side edge and the second side edge of their image modulators to be opposite to each other.

28. The multi-screen joined diffraction display system according to claim 22, wherein the image modulators of the first optical engine and the second optical engine are integrated into one.

29. The multi-screen joined diffraction display system according to claim 22, wherein the first optical engine and the second optical engine share the laser light source and/or the light diffusing device.

30. The multi-screen joined diffraction display system according to claim 22, wherein the first optical engine and the second optical engine are arranged to be spatially distant from each other.

31. The multi-screen joined diffraction display system according to claim 22, wherein the display system is a HUD system.

32. The multi-screen joined diffraction display system according to claim 22, wherein the width of a gap between the first diffractive projection screen and the second diffractive projection screen is less than or equal to 2 mm; and preferably, the first diffractive projection screen and the second diffractive projection screen are seamlessly joined.

33. The multi-screen joined diffraction display system according to claim 32, wherein the image modulator is a DMD or a MEMS-based scanning galvanometer.

34. The multi-screen joined diffraction display system according to claim 33, wherein the light diffusing device is a diffusing screen arranged downstream of the image modulator along the optical path from the laser light source to the display surface, the display surface is formed on the diffusing screen, and the diffusing screen is configured to adjust the light beams emitted therefrom corresponding to each pixel to have a specific spatial angular distribution, such that the light energy is concentrated for projection towards the corresponding diffractive projection screen.

35. The multi-screen joined diffraction display system according to claim 22, wherein the first optical engine projects a target image output therefrom only onto the first diffractive projection screen, and the second optical engine projects a target image output therefrom only onto the second diffractive projection screen.

36. The multi-screen joined diffraction display system according to claim 22, wherein the light diffusing device comprises a scattering element, a micro mirror array, a micro prism array, a micro lens array, a HOE, a CGH, a DOE or a combination thereof.

37. The multi-screen joined diffraction display system according to claim 22, wherein the light diffusing device is further configured to adjust the light beams emitted therefrom corresponding to each pixel to have a specific spatial angular distribution, such that the light energy is concentrated for projection towards the diffractive projection screen.

38. The multi-screen joined diffraction display system according to claim 37, wherein center light of the light beams emitted by the light diffusing device corresponding to each pixel deviates from a direction perpendicular to the light diffusing device.

39. The multi-screen joined diffraction display system according to claim 37, wherein the light diffusing device comprises at least one of an aperture array, a micro mirror array, a micro prism array, a micro lens array, a grating, a HOE, a CGH and a DOE.

40. The multi-screen joined diffraction display system according to claim 22, wherein the optical engine further comprises a directional projecting device arranged downstream of the light diffusing device along the optical path from the laser light source to the display surface, and the directional projecting device is configured to limit a divergence angle of the light beams emitted therefrom corresponding to each pixel and/or change a direction of the center light of the light beams to enable the light beams to have a specific spatial angular distribution, such that the light energy is concentrated for projection towards the diffractive projection screen.

41. The multi-screen joined diffraction display system according to claim 40, wherein center light of the light beams emitted by the directional projecting device corresponding to each pixel deviates from a direction perpendicular to the directional projecting device.

42. The multi-screen joined diffraction display system according to claim 40, wherein the directional projecting device is arranged upstream of the image modulator along the optical path from the coherent light source to the display surface, and the display surface is formed on the image modulator; or
the directional projecting device is arranged downstream of the image modulator along the optical path from the laser light source to the display surface, and the display surface is formed on the directional projecting device.

43. The multi-screen joined diffraction display system according to claim 40, wherein the directional projecting device comprises an aperture array, a micro mirror array, a micro prism array, a micro lens array, a grating, a HOE, a CGH, a DOE, or a combination thereof.
